(19) United States
(12) Patent Application Publication
(10) Pub. No.: US 2008/0263290 A1
(43) Pub. Date: Oct. 23, 2008

(54) MEMORY CONTROL APPARATUS AND MEMORY CONTROL METHOD

(75) Inventor: Masahiro YAMADA, Nishitama-gun (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 12/104,052

(22) Filed: Apr. 16, 2008

(30) Foreign Application Priority Data
Apr. 20, 2007 (JP) 2007-112220

(51) Int. Cl. G06F 12/00

(52) U.S. Cl. 711/154; 711/E12.001

(57) ABSTRACT

According to one embodiment, a memory control apparatus controls a memory having a plurality of banks. This memory control apparatus has an access control section controlling such that a second access request issued from a second access unit is accepted after a first access request issued from a first access unit is accepted. This access control section controls so as to accept an access request to a non-access bank which is different from a bank accessed by the first access request and having low possibility of being accessed by the first access unit continuously, among the second access requests.

### CROSS-REFERENCE TO RELATED APPLICATIONS

This application is based upon and claims the benefit of priority from Japanese Patent Application No. 2007-112220, filed Apr. 20, 2007, the entire contents of which are incorporated herein by reference.

### BACKGROUND

1. Field

One embodiment of the invention relates to a memory control apparatus and a memory control method controlling a memory having a plurality of banks.

2. Description of the Related Art

Conventionally, a synchronous dynamic random access memory (hereinafter, referred to as an SDRAM) is used as a main memory of an information processing apparatus such as a personal computer. The SDRAM is a synchronous memory enabling to perform a burst transfer of a cash memory in high speed while synchronizing with a clock.

This SDRAM can perform read/write of data by every continuous clock in a burst access in which continuous addresses are specified to perform the read/write of data. In this case, a maximum value of a memory bandwidth (an amount of data read out for one second) is asked by a clock frequency x bit width.

However, it is impossible to access to the SDRAM during a period between two burst accesses. Accordingly, the memory bandwidth is lowered if there is a time between the two burst accesses.

Conventionally, there has been a continuous access mode in which the accesses are performed by dividing inside the SDRAM into a plurality of (two to four) banks. In this continuous access mode, the accesses are performed continuously to the respective banks while switching the banks to be accessed by a clock control.

Besides, in the continuous access mode by the bank division, a time loss occurs until a precharge operation to the bank completes if access requests to the same bank continue. Accordingly, an art is already known in which an order of the access requests is replaced so that the access requests to the same bank do not continue.

According to the above-stated art, an access request to a bank other than the bank which is accessed by the burst access is accepted during an execution of the burst access, and therefore, it is possible to continuously execute a next burst access just after the former burst access.

When an access unit issuing the access request to the SDRAM is only one, the above-stated art can correspond to.

However, when plural access units access to the SDRAM, a possibility in which the respective access units access to the same bank continuously arises because it is difficult to control the banks to which the respective access units issue the access requests with each other.

Conventionally, a memory control apparatus as stated below is therefore disclosed in Patent Publication No. 3819004 (Patent Document 1). This memory control apparatus enables continuous accesses to different banks by increasing an order of priority of the access unit outputting the access request to the different bank when plural access units issue the access requests to the SDRAM.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram showing a configuration of a memory control system according to an embodiment of the present invention;

FIG. 2 is an exemplary view showing a relation between banks and addresses of an SDRAM in the embodiment;

FIG. 3 is an exemplary view schematically showing a relation between access requests from a CPU and a video processing module and the banks of the SDRAM in the memory control system according to the embodiment of the present invention;

FIG. 4 is an exemplary block diagram showing a configuration of the video processing module in the embodiment;

FIG. 5 is an exemplary view schematically showing a relation between the access requests from the CPU and the video processing module and the banks of the SDRAM to compare with the memory control system according to the embodiment of the present invention; and

FIG. 6(a) and FIG. 6(b) are exemplary views schematically showing a prediction of the bank at a bank prediction unit, and a determination of the access request at an access control unit, in which FIG. 6(a) shows a case when the number of banks is four, and FIG. 6(b) shows a case when the number of banks is five in the embodiment.

### DETAILED DESCRIPTION

Various embodiments according to the invention will be described hereinafter with reference to the accompanying drawings. In general, according to one embodiment of the invention, a memory control apparatus controls a memory having a plurality of banks.

A memory control apparatus has an access control section controlling to accept a second access request issued from a second access unit after a first access request issued from a first access unit is accepted.

This access control section controls so as to accept an access request to a non-access bank which is different from a bank accessed by the first access request and having low possibility of being accessed by the first access unit continuously among the second access requests.

Besides, in a memory control method controlling a memory having a plurality of banks, the control is performed as stated below. It is controlled such that a second access request issued from a second access unit is accepted after a first access request issued from a first access unit is accepted.

Further, it is controlled so as to accept an access request to a non-access bank which is different from a bank accessed by the first access request and having low possibility of being accessed by the first access unit continuously among the second access requests.

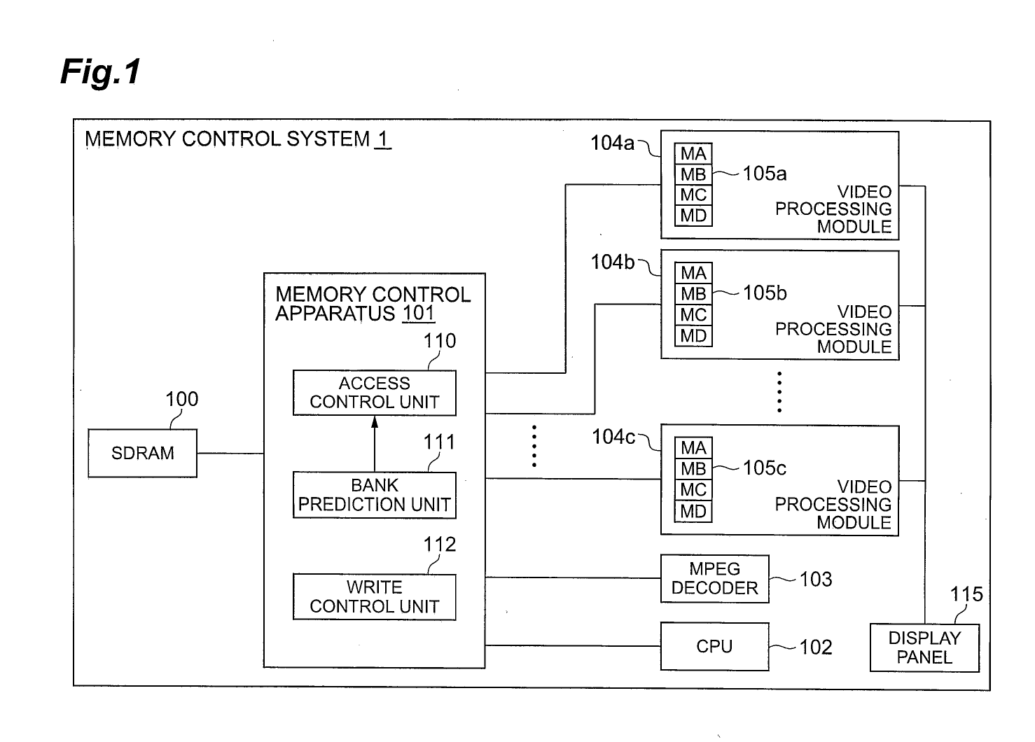

FIG. 1 is a block diagram showing a configuration of a memory control system 1 according to an embodiment of the present invention. The memory control system 1 has an SDRAM 100, a memory control apparatus 101 controlling accesses to the SDRAM 100, and a display panel 115 displaying a video by using signals controlled at the memory control apparatus 101.

Besides, the memory control system 1 has a CPU (Central Processing Unit) 102, an MPEG (Moving Picture Experts Group) decoder 103, and a plurality of (“n” pieces of) video processing modules 104a, 104b . . . 104c.

In the memory control system 1, the memory control apparatus 101 controls access requests issued by the CPU 102 and the MPEG decoder 103 as discontinuous processing modules, and access requests issued by the video processing modules 104a, 104b . . . 104c as continuous processing modules so that accesses to different banks may continue.

Incidentally, the discontinuous processing module is a first access unit, and the access request issued from here is a first access request. Besides, the continuous processing module is a second access unit, and the access request issued from here is a second access request.

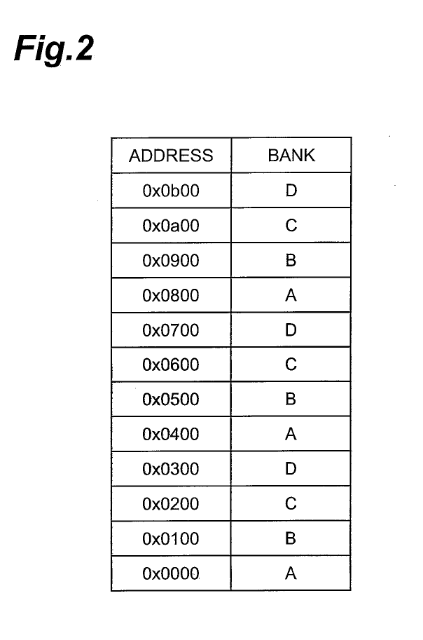

The SDRAM 100 is a synchronous memory, and an inside thereof is divided into four banks of A, B, C and D. As shown in FIG. 2, a relation between the banks A, B, C and D and addresses is defined such that every 256 bytes becomes one bank in the SDRAM 100.

Incidentally, this relation between the banks A, B, C and D and the addresses is not limited to every 256 bytes as stated above. Besides, the SDRAM 100 is divided into four banks of A, B, C and D, but it is good if the SDRAM 100 is divided into at least four banks, and the number of the banks may be four or more.

The memory control apparatus 101 has an access control unit 110, a bank prediction unit 111, and a write control unit 112. Besides, the memory control apparatus 101 controls a video display by the display panel 115 using the controlled signals.

The access control unit 110 controls an order of the access requests from the CPU 102, the MPEG decoder 103, and the video processing modules 104a, 104b . . . 104c such that the access requests to the different banks may continue.

In this case, the access control unit 110 controls the order of the access requests such that the access request from the continuous processing module (for example, the video processing module 104a) is accepted after the access request from the discontinuous processing module (for example, the CPU 102) is accepted.

The bank prediction unit 111 predicts the bank to which the discontinuous processing module (for example, the CPU 102) tries to access continuously by the access request after the access request is issued.

The write control unit 112 controls writings of data read out from the SDRAM 100 by the access requests from the video processing modules 104a, 104b . . . 104c to later-described buffer memories 105a, 105b . . . 105c.

The CPU 102 is an apparatus executing programs stored in the SDRAM 100, receives data from not-shown input apparatus and storage apparatus, and outputs the data to an output apparatus and the storage apparatus after computation and processing are performed. Besides, the CPU 102 outputs the access requests to the SDRAM 100 via the memory control apparatus 101 when the above-stated operations are performed.

The MPEG decoder 103 reproduces a video signal by performing a decoding process of data coded by an MPEG method. Besides, the MPEG decoder 103 outputs the access requests to the SDRAM 100 via the memory control apparatus 101 when the decoding process is performed.

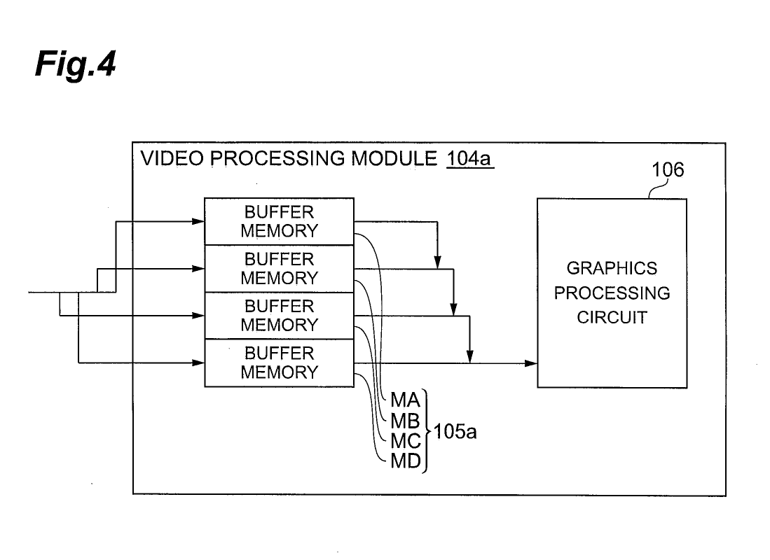

The video processing modules 104a, 104b . . . 104c have the same constitution, and therefore, the video processing module 104a is described with reference to FIG. 4. As shown in FIG. 4, the video processing module 104a has the buffer memory 105a and a graphics processing circuit 106. The buffer memory 105a has four storage sections MA, MB, MC and MD assigned to the respective banks of the SDRAM 100.

The data read out from the SDRAM 100 are stored at the buffer memory 105a. The graphics processing circuit 106 reads the data from the MA, MB, MC and MD of the buffer memory 105a in this sequence, performs a predetermined video signal processing, and outputs video data.

Next, operation contents of the memory control system 1 are described focusing on operation contents of the memory control apparatus 101.

In the following description, it is assumed that both the CPU 102 and the video processing module 104a issue the access requests to the SDRAM 100.

The memory control apparatus 101 accepts the access requests trying to access to the plurality of banks from the CPU 102 and the video processing module 104a respectively. In this case, the access control unit 110 changes the order of the access requests such that the access request from the video processing module 104a is accepted after the access request from the CPU 102.

Here, if it is assumed that the memory control apparatus 101 accepts any access request to the banks different from the bank which is accessed by the CPU 102, among the access requests from the video processing module 104a. Then, there is a case when the bank becomes the same between the access request from the video processing module 104a and the access request from the CPU 102 when it is issued again.

For example, it is assumed that any access requests from the video processing module 104a to the banks B, C, D which are different from the bank A are to be accepted because the access request of the CPU 102 is the access request to the bank A. Accordingly, there is a case when even the access request to the bank (for example, the bank B) having high possibility of being accessed by the CPU 102 next may be accepted. As a result, the bank becomes the same as the bank of the access request of the video processing module 104a.

As a result, the access control unit 110 accepts the access request trying to access to the bank which may not be accessed by the CPU 102 (the bank having low (few) possibility of being accessed by the CPU 102 continuously, hereinafter it is referred to as a “non-access bank”) among the access requests from the video processing module 104a, after the access request from the CPU 102 is accepted.

At this time, the bank prediction unit 111 predicts the banks to which the CPU 102 tries to access by a subsequent access request after the access request is issued, in the memory control apparatus 101. The banks predicted by the bank prediction unit 111 are called as prediction banks.

The access control unit 110 determines which access request to which bank is to be accepted among the access requests from the video processing module 104a after the access request of the CPU 102, based on a predicted result of the bank prediction unit 111.

In this case, the access control unit 110 regards the bank which is different from the prediction banks predicted by the bank prediction unit 111 as the non-access bank, and accepts the access request trying to access to the bank after the access request of the CPU 102, among the access requests from the video processing module 104a.

The CPU 102 is the discontinuous processing unit, and therefore, it cannot be said that it is determined in advance that the CPU 102 accesses to the continuous banks when the CPU 102 accesses to the SDRAM 100, that is different from the video processing module 104a. Accordingly, it is rare case that regularity, such as the access requests of the video processing module 104a, appears in a series of banks in which the CPU 102 tries to access in the continuous access requests.

However, in the continuous access requests of the CPU 102, it is possible to predict the bank having high possibility of being accessed subsequently by the CPU 102 from the bank which is once accessed.

Besides, it is possible to decrease a case in which the access requests to the same bank continue by excluding this predicted bank.

Further, the bank to which the CPU 102 tries to access continuously does not become clear unless the access request from the CPU 102 is once accepted.

Accordingly, in the memory control apparatus 101, the access request of the CPU 102 is once accepted, and then, the banks to which the CUP 102 may access subsequently are predicted by the bank prediction unit ill based on the access request, and the bank which is different from the predicted banks (the prediction banks) is regarded as the non-access bank.

It becomes possible to avoid a case when the bank becomes the same as the access request of the video processing module 104a when the CPU 102 issues the access request again by the above-stated operation.

It is conceivable that it is often that the CPU 102 accesses to the same bank or to the banks at both sides again when the CPU 102 accesses continuously. Consequently, for example, when the CPU 102 issues the access request to the bank A, the bank prediction unit 111 predicts that the CPU 102 may access to the same bank A, or the banks B, D at both sides thereof again in the subsequent access request after the above-stated access request, and sets the banks A, B, D as the prediction banks. In this case, the bank A becomes a first bank.

The access control unit 110 accepts the access request to the bank C which is different from the banks A, B, D among the access requests from the video processing module 104a after the access request from the CPU 102 to the bank A is accepted.

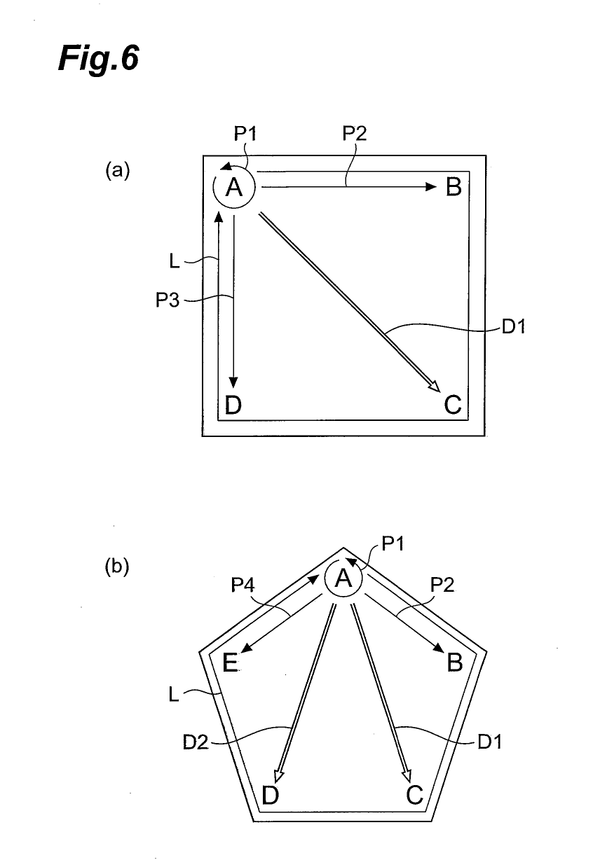

Here, the prediction of the banks at the bank prediction unit 111 and the determination of the access request at the access control unit 110 as stated above are schematically illustrated as shown in FIG. 6(a). In FIG. 6(a), a state in which the banks A, B, C and D are disposed at four corners of a square-shaped area is represented.

The vide processing module 104a is the continuous processing unit, and therefore, it issues the access requests while switching the banks to be accessed in sequence of the banks A, B, C and D along a specified line L in clockwise.

On the other hand, it is rare case in which the regularity as stated above appears in the access requests from the CPU 102. Accordingly, it works such that the bank prediction unit 111 predicts the banks which may be accessed by the CPU 102 again (the banks which are apt to be accessed by the CPU 102), and the access control unit 110 avoids the banks determined by the prediction.

Namely, the access control unit 110 takes a next access request of the CPU 102 in advance, and accepts the access request from the video processing module 104a in a way that the bank which may be accessed by the next access request of the CPU 102 is avoided.

Concretely speaking, the bank prediction unit 111 executes a prediction P1 of which prediction bank is the bank A, or predictions P2, P3 of which prediction banks are the banks B, D respectively, and the access control unit 110 executes a determination D1 accepting the access request to the bank C among the access requests from the video processing module 104a. Consequently, the access control unit 110 accepts the access request to the bank disposed at a diagonal position of the bank which is accessed by the CPU 102.

Besides, when the SDRAM 100 has five banks of the banks A, B, C, D and E, it becomes as shown in FIG. 6(b). In this case, the bank prediction unit 111 executes the above-stated prediction P1, prediction P2, and executes a prediction P4 setting the bank E as the prediction bank. The access control unit 110 executes a determination D2 accepting the access request to the bank D in addition to the determination D1.

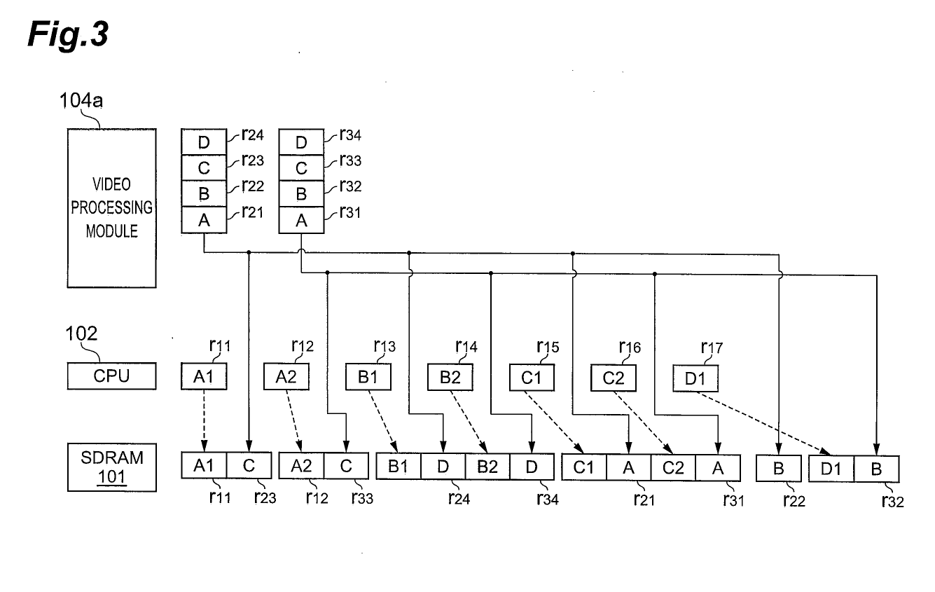

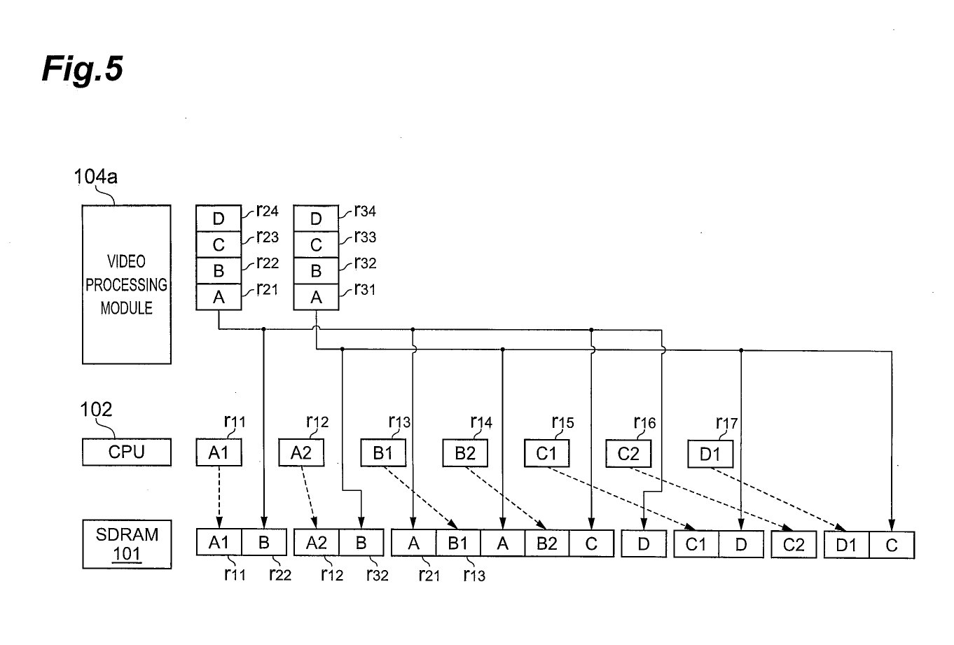

Next, the operations as stated above are concretely described with reference to FIG. 3 and FIG. 5. Here, the CPU 102 accesses to the bank A twice, the bank B twice, the bank C twice, and the bank D once. Namely, the CPU 102 issues access requests r11, r12, r13, r14, r15, r16 and r17 shown in FIG. 3.

Besides, the video processing module 104a issues access requests r21, r22, r23 and r24 and access requests r31, r32, r33 and r34. In the access requests r21, r22, r23 and r24 and the access requests r31, r32, r33 and r34, the banks to be accessed are respectively switched in the sequence of the banks A, B, C and D.

The access control unit 110 accepts any of the access requests r21, r22, r23 or r24 from the video processing module 104a after the access request r11 from the CPU 102 is accepted.

In this case, the banks to which the CPU 102 tries to access continuously are the same bank as the bank accessed by the access request r11 and the banks at both sides thereof. Accordingly, the bank prediction unit 111 sets the banks A, B and D as the prediction banks and notifies the predicted result to the access control unit 110.

The access control unit 110 accepts the access request r23 to the bank C excluding the access requests to the banks A, B and D among the access requests from the video processing module 104a. Then, the access request r11 from the CPU 102 and the access request r23 from the video processing module 104a continue. Moreover, these access requests are the access requests to the different banks.

Next, the access control unit 110 accepts the access request r12 from the CPU 102, and thereafter, accepts any of the access requests r21, r22, r24, r31, r32, r33 or r34 from the video processing module 104a. The prediction banks are the banks A, B, D in this case also.

Accordingly, the access control unit 110 accepts the access request r33 from the video processing module 104a after the access request r12 from the CPU 102 is accepted. As a result, the access requests to the different banks continue in this case also.

Further, the access control unit 110 accepts the access request r13 from the CPU 102, and thereafter, accepts any of the access requests r21, r22, r24, r31, r32 or r34 from the video processing module 104a. In this case, the access request r13 is the access request to a bank B1, and therefore, the prediction banks are the banks B, A and C.

The access control unit 110 therefore accepts the access request r24 from the video processing module 104a after the access request r13 from the CPU 102 is accepted. As a result, the access requests to the different banks continue in this case also.

The access control unit 110 accepts the access requests r13, r14, r15, r16 and r17 from the CPU 102 as same as the above, and thereafter, accepts the access request to the banks other than the same bank to which the CPU 102 accessed in the access requests r13, r14, r15, r16 and r17 and the banks at both sides thereof, among the access requests from the video processing module 104a. Incidentally, the other access requests from the video processing module 104a are continuously accepted subsequent to the access request from the CPU 102 without inserting access requests from other units.

According to the operations as stated above, the access request from the CPU 102 and the access request from the video processing module 104a continue. Further, the access requests from both become the access requests to the different banks.

The CPU 102 is the discontinuous processing unit, and therefore, it is rare case to specify continuous addresses in the continuous access requests, and the banks to be accessed tend to be random. Consequently, the access request from the CPU 102 is issued in addition to the access request from the video processing module 104a, and thereby, it becomes difficult to continuously process the access requests to the different banks.

Accordingly, the memory control apparatus 101 controls the order of the access requests such that the access request from the video processing module 104a is accepted after the access request from the CPU 102 is accepted first. In addition, the banks to which the CPU 102 tries to access again are predicted after the access request from the CPU 102 is accepted, and the access request to the bank different from the predicted prediction banks is accepted.

The memory control apparatus 101 controls so that both banks of the access request from the CPU 102 and the access request from the video processing module 104a do not become the same as stated above.

On the other hand, if any access requests of the video processing module 104a to the banks B, C or D which are different from the bank A are accepted after the access request of the CPU 102 to the bank A is accepted, the state becomes as shown in FIG. 5.

The access requests r22, r32 from the video processing module 104a are respectively accepted after the access requests r11, r12 from the CPU 102 as shown in FIG. 5. The banks to be accessed are banks A1, B, A2, B in the respective access requests, and therefore, the access requests to the different banks continue.

However, if the CPU 102 issues the access request r13 at the time when the access request r32 from the video processing module 104a is accepted, the bank becomes the same because both access requests are to the bank B.

As a result, it becomes impossible to increase the memory bandwidth because the access requests to the different banks do not continue. In this case, the access request r21 from the video processing module 104a is accepted, and thereafter, the access request r13 from the CPU 102 is accepted. Accordingly, process speed of the CPU 102 slows down, and latency of the CPU 102 becomes worse.

As stated above, the memory control apparatus 101 accepts the access request from the video processing module 104a so as to make the banks to which the CPU 102 tries to access continuously (these banks are the prediction banks) free, by heading off the access request from the CPU 102.

Accordingly, it seems that the bank to which the CPU 102 tries to access is always free without being accessed by other units (for example, the video processing module 104a) when it is seen from the CPU 102.

On the other hand, in the memory control apparatus 101, the access control unit 110 changes the order of the access requests from the video processing module 104a in accordance with the access requests from the CPU 102. Accordingly, the banks of the continuous access requests from the video processing module 104a do not continue. The video processing module 104a is not always able to read the data from the banks A, B, C and D in sequence.

As a result, the write control unit 112 controls the write of the data, read out by the access requests from the video processing module 104a, as stated below in the memory control apparatus 101.

The buffer memory 105a is assigned so as to correspond to the respective banks of the SDRAM 100. Accordingly, the write control unit 112 stores the data read out from the respective banks to corresponding storage sections (either of MA, MB, MC or MD) of the buffer memory 105a.

In the video processing module 104a, the graphics processing circuit 106 reads the data from the corresponding storage sections (either of MA, MB, MC or MD) of the buffer memory 105a sequentially, and thereby, it becomes possible to perform the process as same as the case when the continuous addresses are specified.

Incidentally, in the above-stated embodiment, the SDRAM 100 is explained as an example, but the present invention can be applied to other synchronous memories without being limited to the SDRAM, and a similar effect to the case of the SDRAM 100 can be obtained.

Besides, the prediction of the banks to which the CPU 102 tries to access continuously may be performed as follows. Actual accesses in the past of the CPU 102 are held, and the bank to which the CPU 102 may access next is predicted by the bank prediction unit 111 based on the actual accesses. The actual accesses may be the accumulated number of accesses of the respective banks, or access frequencies per unit of time. It becomes possible to improve an accuracy of the prediction by predicting the bank which may be accessed next based on these actual accesses.

Further, the prediction banks are not necessarily be the same bank as the bank which is accessed and the banks at both sides thereof. For example, the same bank as the bank which is accessed and the next bank at one side may be the prediction banks.

Further, the banks to which the CPU 102 tries to access continuously are not predicted but determined, and the access request from the video processing module 104a may be accepted excluding the access requests to the banks. For example, the banks to which the CPU 102 tries to access continuously are determined to be the same bank as the bank which is accessed by the access request and the banks at both sides thereof, and the access request from the video processing module 104a may be accepted while excluding the access requests to these banks.

The above explanation is for explaining the embodiment of the present invention and does not limit the apparatus and the method of the invention, and various modification examples thereof can be implemented easily. Further, an apparatus or a method formed by appropriately combining the components, functions, features or method steps in each embodiment is also included in the present invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A memory control apparatus controlling a memory having a plurality of banks, comprising
an access control section controlling such that a second access request issued from a second access unit is accepted after a first access request issued from a first access unit is accepted,
said access control section controlling to accept an access request to a non-access bank which is different from a bank accessed by the first access request and having low possibility of being accessed by the first access unit continuously among the second access requests.

2. The memory control apparatus according to claim 1, further comprising
a bank prediction section predicting the banks to which the first access unit tries to access continuously after the first access request,
wherein said access control section regards a bank different from the prediction banks predicted by said bank prediction section as the non-access bank, and controls to accept the access request.

3. The memory control apparatus according to claim 2,
wherein said bank prediction section sets a first bank to which the first access unit accessed in the first access request as the prediction bank.

4. The memory control apparatus according to claim 2,
wherein said bank prediction section sets the first bank to which the first access unit accessed in the first access request and a bank next to the first bank as the prediction banks.

5. The memory control apparatus according to claim 1, further comprising
a write control section controlling a writing of data read out from the memory by the second access request to a buffer memory included in the second access unit.

6. The memory control apparatus according to claim 1,
wherein a central processing unit is set as the first access unit, and continuous processing modules reading out data from the memory by specifying continuous addresses are set as the second access unit.

7. The memory control apparatus according to claim 1,
wherein the memory having at lest four banks as the plurality of banks is controlled.

8. The memory control apparatus according to claim 1,
wherein the memory is a synchronous memory.

9. The memory control apparatus according to claim 1,
wherein a video display at a display panel is controlled.

10. A memory control method controlling a memory having a plurality of banks, comprising:
controlling to accept a second access request issued from a second access unit after a first access request issued from a first access unit is accepted; and
controlling to accept an access request to a non-access bank which is different from a bank accessed by the first access request and having low possibility of being accessed by the first access unit continuously, among the second access requests.
